(19) United States
(12) Patent Application Publication
(10) Pub. No.: US 2017/0297196 A1
(43) Pub. Date: Oct. 19, 2017

(54) WORKING ROBOT AND WORKING SYSTEM

(71) Applicant: Kabushiki Kaisha Yaskawa Denki, Kitakyushu-shi (JP)

(72) Inventors: Haruhiko KOIKE, Kitakyushu-shi (JP); Kanji WATANABE, Kitakyushu-shi (JP); Koji HARA, Kitakyushu-shi (JP)

(73) Assignee: Kabushiki Kaisha Yaskawa Denki, Kitakyushu-shi (JP)

(21) Appl. No.: 15/475,524

(22) Filed: Mar. 31, 2017

(30) Foreign Application Priority Data
Apr. 15, 2016 (JP) 2016-082420

(51) Int. Cl. B25J 9/00; G05B 19/418

(52) U.S. Cl. CPC B25J 9/0093; G05B 19/41815; G05B 2219/39102

(57) ABSTRACT

A working robot includes a robot arm that includes arm members turnably coupled, a control box that houses a controller that controls operation of the robot arm, and a support frame that supports the control box and the robot arm such that an installation position of the control box and an installation position of the robot arm overlap when viewing from a vertical direction, a clearance is formed between the control box and the robot arm, and one or more directions of the clearance are in an opened state.

### CROSS-REFERENCE TO RELATED APPLICATION

This application claims priority from Japanese Patent Application No. 2016-082420 filed with the Japan Patent Office on Apr. 15, 2016, the entire content of which is hereby incorporated by reference.

### BACKGROUND OF THE INVENTION

### Field of the Invention

The embodiments disclosed herein relate to a working robot and a working system.

### Description of Background Art

A working robot may be disposed at the proximity of a conveying device, which conveys a workpiece, and performs a predetermined work for the conveyed workpiece. For example, JP-A-05-262333 describes a food-dish-up apparatus. This food-dish-up apparatus dishes up various food products such as a prepared food at a determined position of a lunch tray conveyed by a belt conveyor.

### SUMMARY OF THE INVENTION

According to one aspect of the present invention, a working robot includes a robot arm that includes arm members turnably coupled, a control box that houses a controller that controls operation of the robot arm, and a support frame that supports the control box and the robot arm such that an installation position of the control box and an installation position of the robot arm overlap when viewing from a vertical direction, a clearance is formed between the control box and the robot arm, and one or more directions of the clearance are in an opened state.

According to another aspect of the present invention, a working system includes a working robot that performs a predetermined work for a workpiece, and a conveying device that conveys the workpiece. The working robot includes a robot arm including arm members turnably coupled, a control box housing a controller that controls operation of the robot arm, and a support frame supporting the control box and the robot arm such that an installation position of the control box and an installation position of the robot arm overlap when viewing from a vertical direction, a clearance is formed between the control box and the robot arm, and at least one direction of the clearance is in an opened state, and the conveying device is positioned to pass through the clearance of the working robot.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an explanatory view representing an exemplary overall configuration of a working system according to an embodiment;

FIG. 2 is a front view representing an exemplary configuration of a working robot;

FIG. 3 is a top view representing an exemplary configuration of the working robot;

FIG. 4 is a right side view representing an exemplary configuration of the working robot;

FIG. 5 is a conceptual cross-sectional view representing an exemplary internal structure of a robot arm of the working robot;

FIG. 6 is an explanatory view representing a configuration of a working system of a comparative example;

FIG. 7 is an explanatory view representing an exemplary overall configuration of a working system of a modification, which conveys food product containers in two rows on a conveyance conveyor;

FIG. 8 is an explanatory view representing an exemplary overall configuration of a working system of a modification, which includes a tray supply device and a tray recovery device;

FIG. 9A is a top view representing an exemplary configuration of the tray supply device;

FIG. 9B is a top view representing an exemplary configuration of the tray recovery device;

FIG. 10 is an explanatory view representing an exemplary overall configuration of a working system of a modification, which includes the tray supply device and the tray recovery device and conveys the food product containers in two rows;

FIG. 11 is an explanatory view representing an exemplary situation where a stock device stocks the food product container in the working system of the modification, which includes the stock device; and

FIG. 12 is an explanatory view representing an exemplary situation where the stock device returns the stocked food product container to the conveyance conveyor in the working system of the modification, which includes the stock device.

### DESCRIPTION OF THE EMBODIMENTS

In the following detailed description, numerous details are set forth in order to provide a thorough understanding of embodiments according to the present invention.

### Embodiment

The following describes one embodiment with reference to the drawings. In the following description, for convenience of explanation of configurations of the working robot and the like, directions such as upper and lower, right and left, and front and rear may be used as necessary. However, these directions do not limit positional relationships of the respective configurations of the working robot and the like.

### Overall Configuration of Working System

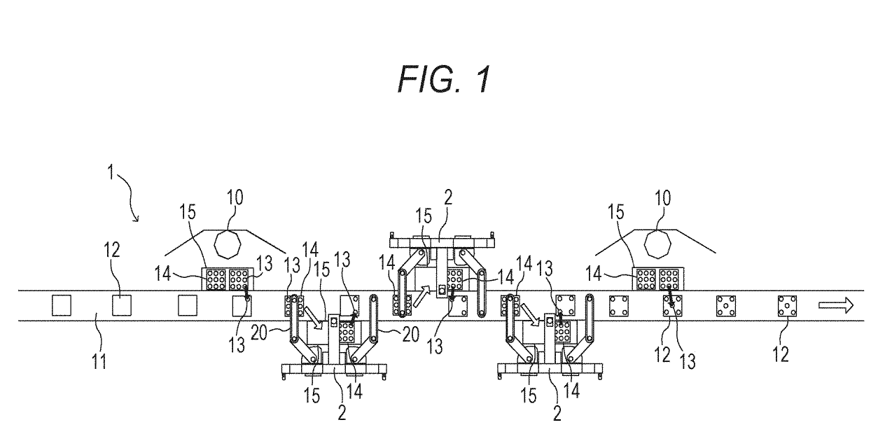

With FIG. 1, an overall configuration of a working system 1 according to an embodiment of the present invention will be described. The working system 1 of the embodiment configures a working line that dishes up a food product 13 (an exemplary part) in a food product container 12 (an exemplary workpiece).

The working system 1 includes a conveyance conveyor 11 (an exemplary conveying device), conveys the food product container 12, and working robots 2. The working robots 2 are disposed at the proximity of the conveyance conveyor 11, and perform the dish up of the food product 13 (an exemplary predetermined work) with respect to the food product container 12. In an example illustrated in FIG. 1, multiple workers 10 (two in this example) are also disposed at the proximity of the conveyance conveyor 11. The worker 10 performs the dish up of the food product 13 with respect to the food product container 12 together with the multiple working robots 2 (three in this example). Thus, the working system 1 is a working system also including the workers 10. Instead of the workers 10, the working robots 2 may be additionally disposed.

In the example illustrated in FIG. 1, three working robots 2 and two workers 10 are at approximately regular intervals with respect to the conveyance conveyor 11 as follows. That is, from an upstream side (a left side in FIG. 1), a worker 10 is disposed first, a working robot 2 is disposed second, a working robot 2 is disposed third, a working robot 2 is disposed fourth, and a worker 10 is disposed fifth. Among them, from the upstream side, the first worker 10, the third working robot 2, and the fifth worker 10 are disposed at one side in a width direction of the conveyance conveyor 11 (an upper side in FIG. 1). On the other hand, from the upstream side, the second working robot 2 and the fourth working robot 2 are disposed at the other side in the width direction of the conveyance conveyor 11 (a lower side in FIG. 1). The disposition of the working robots 2 and the workers 10 illustrated in FIG. 1 is one example, and may be a disposition other than the above-described disposition.

A supply position (not illustrated) is configured at the upstream side with respect to the above-described first worker 10 of the conveyance conveyor 11. At this supply position, the empty food product container 12 and a food product tray 14 (an exemplary part container) are supplied to the conveyance conveyor 11 at an appropriate timing. The food product 13 such as the prepared food dished up in the food product container 12 is housed in the food product tray 14. The empty food product container 12 is, for example, supplied to the conveyance conveyor 11 at predetermined regular time intervals. The food product tray 14 is, for example, supplied to the conveyance conveyor 11 when one food product tray 14 becomes empty at any of the working robots 2 and the workers 10. Thus, the conveyance conveyor 11 sequentially conveys the food product containers 12 and the food product trays 14, with being mixed, to a downstream side (a right side in FIG. 1).

The food product 13 such as the prepared food dished up in the food product container 12 is housed in the food product tray 14. The multiple food products 13 of one type are housed in one food product tray 14. The food product 13 has multiple types, and is housed in the different food product tray 14 per its type. In this example, the dished-up food products 13, for example, have five types. The respective working robots 2 and the respective workers 10 dish up the food product 13, which is a type corresponding to themselves, in the food product container 12. At the positions close to the conveyance conveyor 11 of the respective workers 10 and the respective working robots 2, respective tray placing tables 15, which hold the food product trays 14, are disposed.

The working robot 2 is a double arm robot including two robot arms 20. The two robot arms 20 project above the conveyance conveyor 11 such that the respective two robot arms 20 are at the upstream side and the downstream side. The respective robot arms 20 are able to each independently operate between the conveyance conveyor 11 and the tray placing table 15 and work. The working robot 2 will be described later in detail.

The three working robots 2 and the two workers 10 dish up the food products 13, which are the respective types corresponding to an order from the upstream side, in the food product container 12.

Specifically, the first worker 10 from the upstream side draws the food product tray 14, where the first type of food product 13 are housed and which flows from the upper stream by the conveyance conveyor 11, onto the tray placing table 15 to hold the food product tray 14. The first worker 10 grips the food product 13 in the food product tray 14 held onto the tray placing table 15, and brings it to a predetermined first dish up position in the empty food product container 12, which flows to the proximity of this worker 10, to dish up it. In this example, the first dish up position is at the proximity of a corner portion at the downstream side and a side close to this worker 10, of the food product container 12.

The second working robot 2 from the upstream side draws the food product tray 14, where the second type of food product 13 are housed and which flows from the upper stream by the conveyance conveyor 11, onto the tray placing table 15 by the robot arm 20 to hold food product tray 14. In FIG. 1, this drawing operation of the food product tray 14 by the robot arm 20 is indicated by a white arrow (the same applies hereinafter). The second working robot 2 grips the food product 13 in the food product tray 14 held onto the tray placing table 15, and brings it to a predetermined second dish up position in the food product container 12, where the first type of food product 13 has been dished up and flows to the proximity of this working robot 2 by the robot arm 20, to dish up it. In this example, the second dish up position is at the proximity of a corner portion at the downstream side and a side close to this working robot 2, of the food product container 12. In FIG. 1, this dish up operation of the food product 13 by the robot arm 20 is indicated by a black arrow (the same applies hereinafter).

The third working robot 2 from the upstream side draws the food product tray 14, where the third type of food product 13 are housed and which flows from the upper stream by the conveyance conveyor 11, onto the tray placing table 15 by the robot arm 20 to hold the food product tray 14. The third working robot 2 grips the food product 13 in the food product tray 14 held onto the tray placing table 15, and brings it to a predetermined third dish up position in the food product container 12, where the first and second types of food products 13 have been dished up and flows to the proximity of this working robot 2 by the robot arm 20, to dish up it. In this example, the third dish up position is at the proximity of a corner portion at the upstream side and a side close to this working robot 2, of the food product container 12.

The fourth working robot 2 from the upstream side draws the food product tray 14, where the fourth type of food product 13 are housed and which flows from the upper stream by the conveyance conveyor 11, onto the tray placing table 15 by the robot arm 20 to hold the food product tray 14. The fourth working robot 2 grips the food product 13 in the food product tray 14 held onto the tray placing table 15, and brings it to a predetermined fourth dish up position in the food product container 12, where the first to third types of food products 13 have been dished up and flows to the proximity of this working robot 2 by the robot arm 20, to dish up it. In this example, the fourth dish up position is at the proximity of a corner portion at the upstream side and a side close to this working robot 2, of the food product container 12.

The fifth worker 10 from the upstream side draws the food product tray 14, where the fifth type of food product 13 are housed, that flows from the upper stream by the conveyance conveyor 11 onto the tray placing table 15 to hold it. The fifth worker 10 grips the food product 13 in the food product tray 14 held onto the tray placing table 15, and brings it to a predetermined fifth dish up position in the food product container 12, where the first to fourth type of food products 13 have been dished up and flows to the proximity of this worker 10, to dish up it. In this example, the fifth dish up position is at the proximity of a center portion of the food product container 12.

The first to fifth, five types of food products 13 have been dished up in the food product container 12 to complete the dish up operation of the food product 13 with respect to the food product container 12. The food product container 12, where the first to fifth food products 13 have been dished up, flows to a post-process facility (not illustrated), which is installed at the downstream side, by the conveyance conveyor 11. At the post-process facility, post-process processing such as putting the lid on the food product container 12 is performed. If the food products 13 in the food product tray 14 held onto the tray placing table 15 are gone and the food product tray 14 becomes empty, the respective workers 10 and the respective working robots 2 return this empty food product tray 14 from on the tray placing table 15 onto the conveyance conveyor 11. The returned empty food product tray 14 is conveyed to a recovery position (not illustrated) at the downstream side to be recovered from on the conveyance conveyor 11.

### Overall Configuration of Working Robot

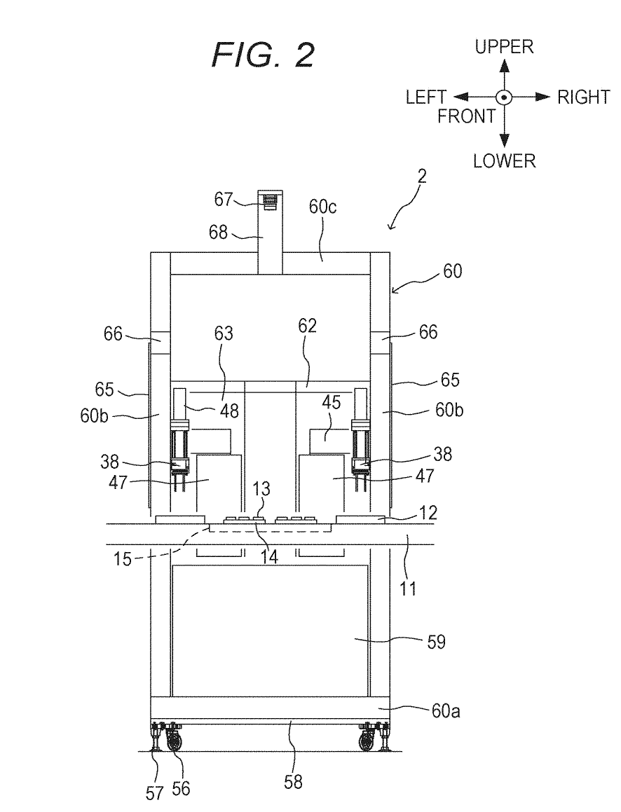

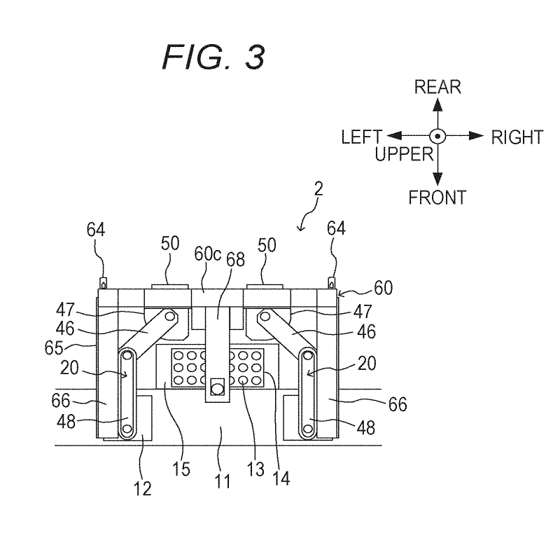

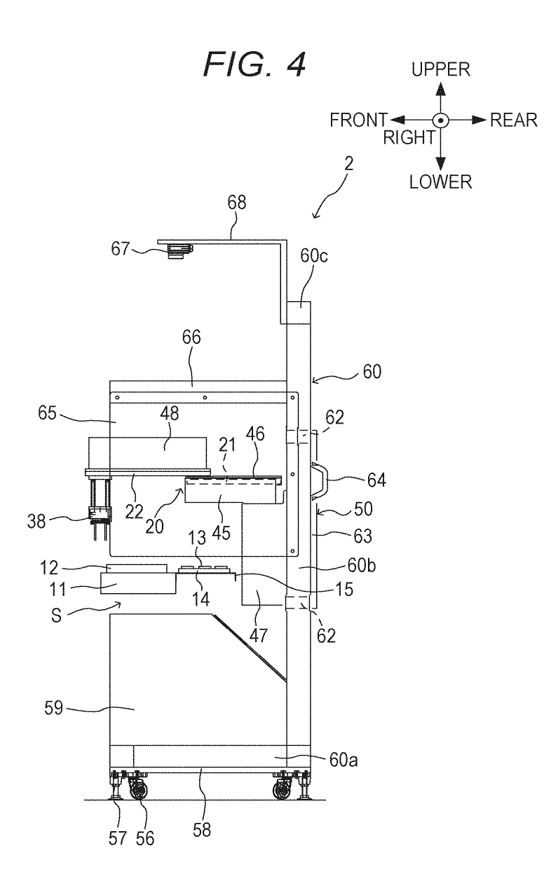

Next, with FIGS. 2 to 4, an overall configuration of the working robot 2 according to an embodiment of the present invention will be described. FIG. 2 is a front view representing an exemplary configuration of the working robot 2. FIG. 3 is a plan view representing an exemplary configuration of the working robot 2. FIG. 4 is a right side view representing an exemplary configuration of the working robot 2.

As illustrated in FIGS. 2 to 4, the working robot 2 includes a right and left pair of above-described robot arms 20, a control box 59, and a support frame 60. The control box 59 houses a controller (not illustrated) that controls the operation of the robot arm 20. The support frame 60 supports the control box 59 and the robot arm 20 so that an installation position of the control box 59 and an installation position of the robot arm 20 overlap viewing from a vertical direction, a clearance (S) (see FIG. 4) is disposed between the control box 59 and the robot arm 20, and at least one direction (in this example, frontward, rightward, and leftward) of the clearance (S) is in an opened state. As illustrated in FIG. 4, the conveyance conveyor 11 is housed (arranged) in the clearance (S). That is, it can be said that the support frame 60 supports the robot arm 20 and the control box 59 so that the control box 59 is disposed below the conveyance conveyor 11 and the robot arm 20 is disposed above the conveyance conveyor 11. The support frame 60 is a square pipe, which is configured of lightweight material (general metal, FRP (fiber-reinforced plastic), or the like), or the like.

The support frame 60 includes a bottom plate frame (60a), support pillar frames (60b), and a coupling frame (60c). The bottom plate frame (60a) is disposed below the conveyance conveyor 11, and has an approximately square shape. The support pillar frames (60b) are disposed upright on right and left backward corner portions of the bottom plate frame (60a). The coupling frame (60c) couples upper ends of the support pillar frames (60b). The control box 59 is installed on the bottom plate frame (60a). That is, the control box 59 is disposed below the clearance (S), that is, below the conveyance conveyor 11. The bottom plate frame (60a) has an inferior surface where a base plate 58, for example, made of stainless steel, as a weight member to lower a center of gravity of the working robot 2 is installed.

An upper and lower pair of beam frames 62 along a right-left direction is disposed between the right and left support pillar frames (60b). A back surface plate 63 is secured to between these pair of the beam frames 62. A pair of vertical movement mechanisms 50 is installed on the back surface plate 63. The pair of vertical movement mechanisms 50 is disposed at base ends side of the respective robot arms 20 to move individually the respective robot arms 20 in the vertical direction. The vertical movement mechanism 50, for example, includes a ball screw mechanism.

The base plate 58 has an inferior surface with four corners on which casters 56 and adjustable legs 57 are disposed. The casters 56 are used for moving the working robot 2 to an installation site. The adjustable legs 57 are used for installing the working robot 2 moved to the installation site at the installation site. The respective support pillar frames (60b) have rear portions where handles 64 are disposed. The handle 64 is used for gripping by the worker when moving the working robot 2.

A pair of safety covers 65 covering right and left side surfaces is disposed on the support frame 60. The safety cover 65 is configured of a rectangular transparent plate or the like. The safety cover 65 parts an operation range of the robot arm 20, and restrains a human, equipment, or the like from interfering with the robot arm 20. The respective safety covers 65 are secured to side surfaces of a pair of cantilevers 66 disposed to protrude ahead from the respective support pillar frames (60b), and side surfaces of the support pillar frames (60b).

A camera 67 is disposed above the working robot 2 so as to straddle the conveyance conveyor 11 and the tray placing table 15. The camera 67 simultaneously monitors condition of the food products 13 in the food product container 12 and the food product tray 14, which are conveyed, and the like. The camera 67 is installed on an inferior surface of a tip portion of an L-shaped frame 68. The L-shaped frame 68 is disposed so as to project upward and ahead from an approximately center portion of the coupling frame (60e).

### Configuration of Robot Arm

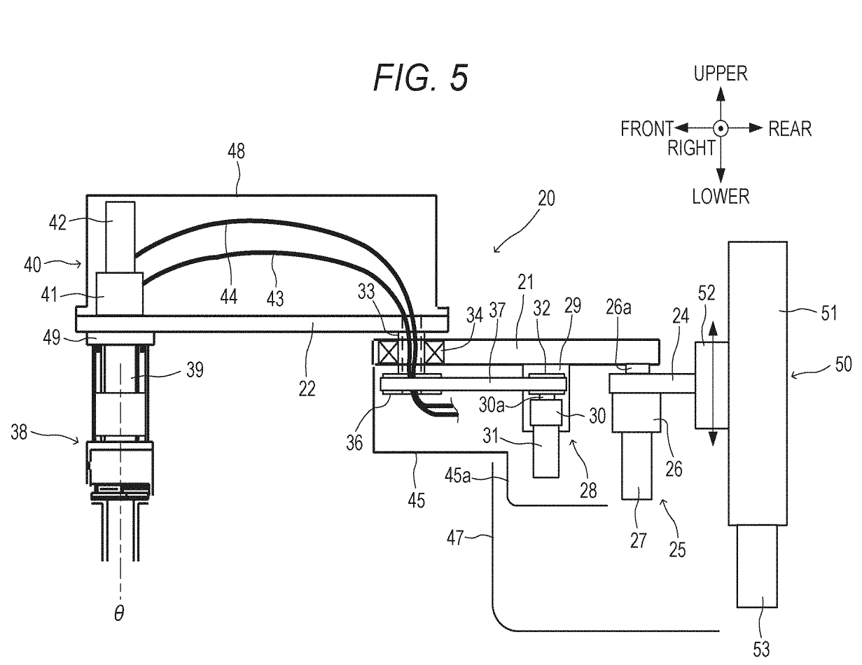

Next, with FIG. 5, a configuration of the robot arm according to an embodiment of the present invention will be described. FIG. 5 is a conceptual cross-sectional view representing an exemplary internal structure of the robot arm.

The robot arm 20 includes multiple turnably coupled arm members, in this example, a first arm member 21 and a second arm member 22. The robot arm 20, which is a horizontal articulated type robot arm, revolves these first arm member 21 and second arm member 22 in a horizontal plane. The first arm member 21 is a plate material with approximately a rectangular shape having a hollow hole (not illustrated). The first arm member 21 is coupled to the vertical movement mechanism 50 so as to be able to revolve with approximately a horizontal posture. The second arm member 22 is a plate material with approximately a rectangular shape without the hollow hole. The second arm member 22 is coupled to a tip of the first arm member 21 so as to be able to revolve with approximately a horizontal posture at an upper side of the first arm member 21.

The first arm member 21 has a base end portion. Below the base end portion, a support plate 24 secured to a slider 52 of the vertical movement mechanism 50 is disposed. This support plate 24 has an upper side where the first arm member 21 is revolvably coupled. The support plate 24 has an inferior surface where a first actuator 25, which revolvingly drives the first arm member 21, is disposed. The first actuator 25 includes a reducer 26 installed on the inferior surface of the support plate 24, and a first motor 27. The first motor 27 is installed below the reducer 26 and coaxially with the reducer 26. The first motor 27 is coupled to an input shaft of the reducer 26. The reducer 26 has an output shaft 26a rotatably supported by the support plate 24. The output shaft (26a) has an upper end secured to the base end portion of the first arm member 21 by passing through the support plate 24.

A second actuator 28 is disposed at the proximity of the first actuator 25, specifically, at a position close to the first actuator 25 with respect to an intermediate position in a longitudinal direction of the first arm member 21. The second actuator 28 revolvingly drives the second arm member 22. The second actuator 28 includes a reducer 30 and a second motor 31. The reducer 30 is installed on an inferior surface of the first arm member 21 via a support member 29. The second motor 31 is installed below the reducer 30, and coaxially with the reducer 30. The second motor 31 is coupled to an input shaft of the reducer 30. The reducer 30 has an output shaft 30a where a drive pulley 32 is coupled.

On the other hand, the second arm member 22 has a base end portion where an upper end portion of an arm shaft 33 with a hollow structure, which passes through a tip portion of the first arm member 21, is secured. The arm shaft 33 is rotatably supported by a bearing 34 disposed on the tip portion of the first arm member 21. The arm shaft 33 has a lower end portion that projects below from the first arm member 21. The arm shaft 33 has a lower end where a driven pulley 36 is coupled. A belt 37, for example, made of rubber, is wound around the drive pulley 32 and the driven pulley 36.

The second arm member 22 has a tip portion. On an inferior surface of the tip portion, a tool 38 is disposed. The tool 38 is used for performing predetermined works such as gripping the food product 13. The tool 38 is not specifically limited. The tool 38, for example, may be an air hand, an electric hand, or a vacuum pad. The tool 38 includes a tool drive mechanism 39 installed on an inferior surface of the second arm member 22. A third actuator 40, which rotates the tool 38 around θ axis, is installed on a top surface of the second arm member 22 (for example, on a top surface of the tip portion of the second arm member 22). The third actuator 40 includes a reducer 41 and a third motor 42. The reducer 41 is installed on the top surface of the second arm member 22. The third motor 42 is installed above the reducer 41, and coaxially with the reducer 41.

A pipe 43 (a pneumatic tube or the like) for driving the tool 38, a wiring 44 for the third actuator 40, and the like are arranged on the second arm member 22. The pipe 43, the wiring 44, and the like are extracted below the first arm member 21 via an inside of the arm shaft 33, and arranged below the first arm member 21 toward a base end side of the robot arm 20.

The first arm member 21 has a lower part where a first arm lower cover 45 (an exemplary first arm cover), which covers the lower part of the first arm member 21, is installed. The first arm lower cover 45 is a box body which upper end side and side of the first actuator 25 are opened. The first arm lower cover 45 has an undersurface bend below into an L-shape so as to cover a lower part of the second actuator 28. The first arm lower cover 45 houses the drive pulley 32, the driven pulley 36, the belt 37, and the second actuator 28, which are disposed below the first arm member 21, and the pipe 43, the wiring 44, and the like, which are extracted from the arm shaft 33.

The first arm member 21 has a top surface where a first arm upper cover 46 (See FIGS. 3 and 4. Not illustrated in FIG. 5) is installed. The first arm upper cover 46 is formed into a dish shape. The first arm upper cover 46 has an upper part where a part such as a screw can be placed. A bend portion 45a of the first arm lower cover 45 and a motor cover 47, which covers lower parts of the first motor 27 and the like, are disposed below the first arm lower cover 45. As illustrated in FIG. 3, the motor cover 47 is a box body where an upper end portion and a side of the support frame 60 are opened. The motor cover 47 is installed on the slider 52 or the support plate 24. Thus, the motor cover 47 is moved in the vertical direction together with the robot arm 20 by the vertical movement mechanism 50. As illustrated in FIGS. 4 and 5, the motor cover 47 has a side surface whose upper part is disposed so as to overlap the bend portion 45a of the first arm lower cover 45 in the vertical direction. In view of this, oil and waste, which are generated by the first actuator 25, the second actuator 28, and the like, are hard to scatter to a side of the tray placing table 15 and the conveyance conveyor 11. As illustrated in FIG. 3, the side surface of the motor cover 47 is formed into approximately a fan shape so as to cover a range of motion of the bend portion 45a of the first arm lower cover 45. Thus, the motor cover 47 has a structure that can avoid the motor cover 47 interfering with the first arm lower cover 45 by the revolving operation of the first arm member 21.

As illustrated in FIG. 5, the second arm member 22 has an upper part where a second arm cover 48, which covers the upper part of the second arm member 22, is installed. The second arm cover 48 is a box body which lower end side is opened. The second arm cover 48 houses internally the third actuator 40, the pipe 43, the wiring 44, and the like. A dish-shaped dust cover 49 for restraining drop of oil and waste, which are generated by the third actuator 40, is installed on the inferior surface of the tip portion of the second arm member 22.

The robot a in 20 having the above-described configuration is moved in the vertical direction by the vertical movement mechanism 50. As illustrated in FIG. 5, the vertical movement mechanism 50 includes a linear motion guide 51 disposed on the back surface plate 63, the slider 52 slidably disposed on the linear motion guide 51, and a Z-axis motor 53. Rotating a screw shaft (not illustrated) by the Z-axis motor 53 moves the slider 52 coupled to the screw shaft in the vertical direction (a Z-axis direction) along the linear motion guide 51.

### Working System of Comparative Example

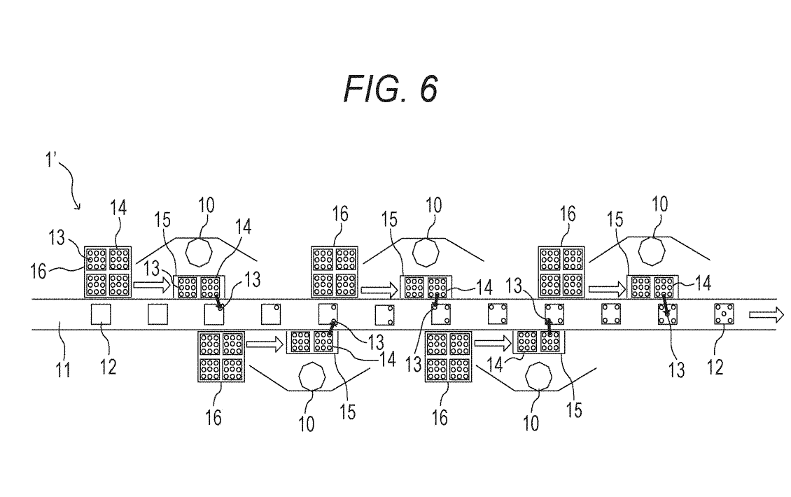

Before describing advantageous effects according to the above-described embodiment, a working system 1′ of a comparative example will be described with FIG. 6.

In the working system 1′, the multiple workers 10 (five in this example) for dishing up the food product 13 with respect to the food product container 12 is disposed at the proximity of the conveyance conveyor 11. Containers 16 (what is called, food containers or the like) are disposed adjacent to the respective workers 10. The multiple food product trays 14 (four in this example) are housed at one tier or multiple tiers in the respective containers 16. The food products 13 having types corresponding to the respective containers 16 are housed in the food product trays 14 housed in the respective containers 16. The containers 16 are loaded into a truck (not illustrated) or the like to be carried by passing through a passage space (not illustrated) ensured behind the workers 10. The container 16 is installed at a predetermined location at the proximity of the worker 10.

The respective workers 10 move the food product tray 14 from the container 16 onto the tray placing table 15 to hold the food product tray 14. The respective workers 10 dish up the food product 13 at a predetermined dish up position in the food product container 12 conveyed by the conveyance conveyor 11. If the food product tray 14 on the tray placing table 15 becomes empty, the empty food product tray 14 is returned to the container 16. The container 16 that houses the empty food product tray 14 is exchanged to the new container 16 as necessary.

Such configured working system 1′ needs a disposing space for the container 16 and a conveying space for conveying the container 16 by a truck or the like. In view of this, saving space for the working system 1′ is difficult. Installation of industrial robots, which need safety frames, instead of the workers 10 is difficult in a plant layout such that the many above-described working systems 1′ are disposed across the conveying spaces. In view of this, it is difficult to reduce the number of workers.

### Advantageous Effect of Embodiment

As described above, in the working system 1 in the embodiment, the working robot 2 is arranged at the proximity of the conveyance conveyor 11. The food product container 12 and the food product tray 14 are supplied on the conveyance conveyor 11. That is, the conveyance conveyor 11 conveys not only the food product container 12, but also the food product container 12 and the food product tray 14 with being mixed. The working robot 2 draws the food product tray 14 conveyed from the upstream side onto the tray placing table 15 to hold it. The working robot 2 performs the dish up operation with respect to the conveyed food product container 12 by using the food product 13 housed in the food product tray 14. The working robot 2 returns the empty food product tray 14 where the housed food product 13 has been used to the conveyance conveyor 11 to convey it to the downstream side. The used food product tray 14 conveyed to the downstream side is recovered from on the conveyance conveyor 11.

Such system configuration eliminates a need for the container 16 (the food container or the like) for housing the food product tray 14. This eliminates a need for the disposing space for the container 16 and the conveying space for conveying the container 16 by a truck or the like. This can save the space for the working system 1.

The working robot 2 includes the robot arm 20, the control box 59, and the support frame 60. The robot arm 20 includes the first arm member 21 and the second arm member 22, which are turnably coupled each other. The control box 59 houses the controller that controls the operation of the robot arm 20. The support frame 60 supports the control box 59 and the robot arm 20 so that the installation position of the control box 59 and the installation position of the robot arm 20 overlap viewing from the vertical direction, the clearance (S) is disposed between the control box 59 and the robot arm 20, and at least one direction of the clearance (S) is in the opened state. These provide next advantageous effects.

That is, the conveyance conveyor 11 is inserted into the above-described clearance S of the working robot 2 from a direction where the clearance (S) is opened (a front direction in the above-described embodiment). In view of this, the conveyance conveyor 11 is arranged so as to pass through the clearance (S). Thus, at the working robot 2, the control box 59 is arranged below the conveyance conveyor 11. Furthermore, the robot arm is arranged above the conveyance conveyor 11. This can arrange the working robot 2 and the control box 59 so as to overlap the conveyance conveyor 11 in a top view. This can save an installation space for the working robot 2. Accordingly, this can save the space for the working system 1. Consequently, this can install the working robots 2 instead of the workers 10 to enable reducing the number of workers.

The support frame 60 can integrate the control box 59 and the robot arm 20. This facilitates a moving work of the working robot 2 compared with a case where the control box 59 is separately placed.

In the embodiment, especially, the robot arm 20 is a horizontal articulated type robot arm including the multiple arm members (21, 22) which revolve in the horizontal plane. The working robot 2 includes the vertical movement mechanism 50, which is disposed at the base end side of the robot arm 20 and moves the robot arm 20 in the vertical direction. These provide next advantageous effects.

A horizontal articulated type (also referred to as a scalar type) robot arm may include a vertical movement mechanism on a tip portion of the robot arm. The vertical movement mechanism moves a tool, which is disposed on a tip portion, for performing a predetermined work, in the vertical direction. In view of this, oil and waste generated from the vertical movement mechanism possibly fall into the food product container 12 and the food product tray 14, which are positioned below.

In the embodiment, the vertical movement mechanism 50 is disposed at the base end side of the robot arm 20. Moving the robot arm 20 in the vertical direction moves the tool 38 in the vertical direction. This can restrain the oil and the waste output from the vertical movement mechanism 50 from falling into the food product container 12 and the food product tray 14. Consequently, this can keep properly hygienic conditions of the food product 13.

In the embodiment, especially, the robot arm 20 includes the first arm member 21, the second arm member 22, the first actuator 25, and the second actuator 28. The first arm member 21 is revolvably coupled to the vertical movement mechanism 50. The second arm member 22 is revolvably coupled to the tip portion of the first awl member 21. The first actuator 25, which is disposed on the base end portion of the first arm member 21, revolvingly drives the first arm member 21. The second actuator 28, which is disposed at the proximity of the first actuator 25, revolvingly drives the second arm member 22. These provide next advantageous effects.

That is, for example, it is supposed that the second actuator 28, which revolvingly drives the second arm member 22, is disposed on the tip portion (a joint portion between the first arm member 21 and the second arm member 22) of the first arm member 21. In this case, the second actuator 28 is possibly arranged above the food product container 12 and the food product tray 14 (or at the proximity of them). In view of this, oil and waste generated from the second actuator 28 possibly fall into the food product container 12 and the food product tray 14, which are positioned below.

In the embodiment, the second actuator 28 is arranged at the proximity of the first actuator 25 disposed at the base end portion of the first arm member 21. This can distance the second actuator 28 from the food product container 12 and the food product tray 14. This can restrain the oil and the waste output from the second actuator 28 from scattering around the food product container 12 and the food product tray 14.

In the embodiment, especially, the robot arm 20 includes the bearing 34 and the arm shaft 33 with the hollow structure. The bearing 34 is disposed on the tip portion of the first arm member 21. The arm shaft 33 is disposed on the base end portion of the second arm member 22 and rotatably supported by the bearing 34. These provide next advantageous effects.

That is, it is supposed that the robot arm 20 does not internally ensure paths for the pipe 43 for the driving of the tool 38, the wiring 44 for the third actuator 40 that rotates the tool 38 around θ axis, and the like. In this case, a wiring duct or a tube is disposed outside the robot arm 20. In this case, friction of the wiring duct or the like possibly generates waste.

In the embodiment, the above-described pipe 43, wiring 44, and the like can be arranged through the inside of the arm shaft 33. In view of this, the paths for the wiring, the pipe, and the like can be ensured inside the robot arm 20. Accordingly, this eliminates a need for disposing the wiring duct or the tube outside the robot arm 20. This can achieve a structure where the source of generation of the waste is little.

In the embodiment, especially, the robot arm 20 includes the drive pulley 32, the driven pulley 36, and the belt 37. The drive pulley 32 is coupled to an output shaft of the second actuator 28 (the output shaft (30a) of the reducer 30). The driven pulley 36 is coupled to the arm shaft 33. The belt 37 is wound the drive pulley 32 and the driven pulley 36. These provide next advantageous effects.

The tip portion of the robot arm 20 (the tip portion of the second arm member 22) operates at high speed. In view of this, in a case of a structure where the output shaft (30a) of the second actuator 28 is directly coupled to the arm shaft 33, impact that the tip portion of the robot arm 20 contacts other equipment or person becomes high.

In the embodiment, driving force of the second actuator 28 is transferred to the second arm member 22 via the belt 37. That is, the driving force of the second actuator 28 is transferred with belt to the second arm member 22. In view of this, the belt 37 serves as a cushion when the tip portion of the robot arm 20 contacts other equipment or person to be able to reduce the impact. Especially, using a rubber belt as the belt 37 can enhance absorption effect of impact. This can improve safety to achieve the working robot that easily coexists with people.

In the embodiment, especially, the robot arm 20 includes the first arm lower cover 45, which covers the lower part of the first arm member 21, and the second arm cover 48, which covers the upper part of the second arm member 22. These provide next advantageous effects.

That is, the first arm lower cover can house the bearing 34, a belt transfer mechanism (including the drive pulley 32, the driven pulley 36, the belt 37, and the like), and the pipe 43, the wiring 44, and the like, which are arranged on the lower part of the first an member 21. This can restrain oil and waste output from them from scattering around and falling into the food product container 12 and the food product tray 14. The second arm cover 48 can house the third actuator 40, and the pipe 43, the wiring 44, and the like, which are arranged on the upper part of the second arm member 22. This can restrain oil and waste output from them from scattering around and falling into the food product container 12 and the food product tray 14.

In the embodiment, especially, the working robot 2 is a double arm robot including the two robot arms 20. This provides next advantageous effects.

That is, assume that when performing the work that dishes up the food product 13 in the food product container 12 as in the embodiment, an object that the robot arm 20 treats is the soft and delicate food product 13. In view of this, too fast operation of the robot arm 20 possibly causes breakage or damage of the food product 13. On the other hand, too slow operation of the robot arm 20 makes take time (time necessary for dishing up one type of food product 13) long. In view of this, the dish up operation with respect to the conveyed food product container 12 possibly becomes late.

In the embodiment, making the working robot 2 the double arm robot can suppress operation speed of the respective robot arms 20 and shorten the take time. This can suppress the damage of the food product 13 and improve productivity at the same time.

### Modification

The disclosed embodiment may be modified in various ways within the scope and the technical idea of the present invention. The following describes such modifications.

### Conveying Food Product Container in Two Rows by Conveyance Conveyor

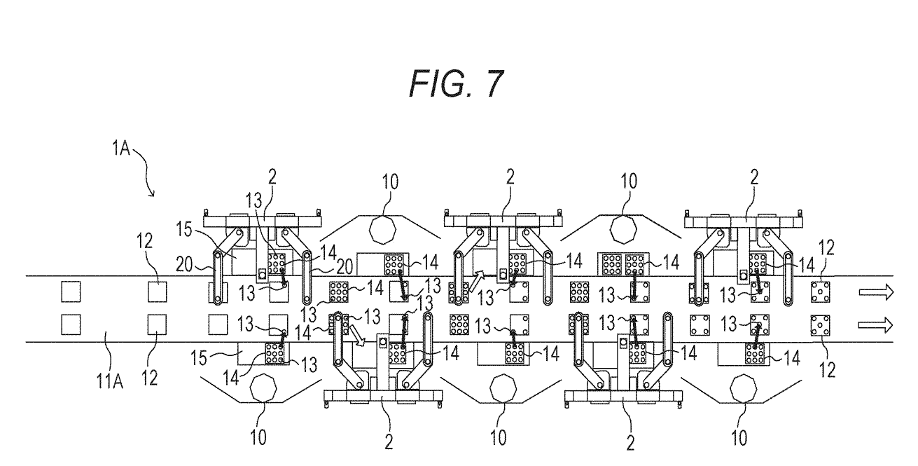

In the above-described embodiment, the food product container 12 is disposed and conveyed in one row on the conveyance conveyor 11. Instead of this, the food product container 12 may be conveyed in two rows on the conveyance conveyor by using a wide conveyance conveyor (a first modification). FIG. 7 illustrates an exemplary configuration of a working system (1A) of this first modification.

As illustrated in FIG. 7, at the working system (1A) in this modification, a conveyance conveyor 11A has a larger dimension in a width direction than that of the conveyance conveyor 11 in the above-described embodiment. The food product containers 12 and the food product trays 14 are disposed and conveyed, with being mixed at both of a position near one side in the width direction (the upper side in FIG. 7) and a position near the other side in the width direction (the lower side in FIG. 7) on the conveyance conveyor (11A). That is, the food product containers 12 and the food product trays 14 are disposed in two rows and conveyed along a longitudinal direction of the conveyance conveyor (11A) on the conveyance conveyor (11A).

In an example illustrated in FIG. 7, the five working robots 2 and the five workers 10 are disposed at the proximity of the conveyance conveyor (11A). That is, the three working robots 2 and the two workers 10 are disposed at the one side in the width direction of the conveyance conveyor (11A). Furthermore, the two working robots 2 and the three workers 10 are disposed at the other side in the width direction of the conveyance conveyor (11A). That is, the working robots 2 are disposed at both sides in the longitudinal direction of the conveyance conveyor (11A). The three working robots 2 and the two workers 10 at the one side in the width direction are disposed at approximately equal intervals from the upstream side (the left side in FIG. 7) to the downstream side (the right side in FIG. 7), in order of the working robot 2, the worker 10, the working robot 2, the worker 10, and the working robot 2. The two working robots 2 and the three workers 10 at the other side in the width direction are disposed at approximately equal intervals from the upstream side to the downstream side, in order of the worker 10, the working robot 2, the worker 10, the working robot 2, and the worker 10. The respective working robots 2 and the respective workers 10 are disposed so as to be opposed to each other in the width direction of the conveyance conveyor (11A).

Each of the three working robots 2 and the two workers 10 at the one side in the width direction dishes up the food product 13 with respect to the food product container 12, which is placed at the one side in the width direction on the conveyance conveyor (11A) and flows from the upstream side. That is, these three working robots 2 and two workers 10 dish up the food product 13, which is a type corresponding to themselves, at a position corresponding to the type of this food product 13 in the food product container 12. Each of the two working robots 2 and the three workers 10 at the other side in the width direction dishes up the food product 13 with respect to the food product container 12, which is placed at the other side in the width direction on the conveyance conveyor (11A) and flows from the upstream side. That is, these two working robots 2 and three workers 10 dish up the food product 13, which is a type corresponding to themselves, at a position corresponding to the type of this food product 13 in the food product container 12. Other configuration in this modification is similar to that in FIG. 1.

In this modification, compared with the above-described embodiment, the number of the food product container 12 conveyed by the conveyance conveyor (11A) can be doubled. And, it is not necessary to dispose an installation space for the container 16 (the food container or the like) for housing the food product tray 14. This can increase the number of processes without making the conveyance conveyor (11A) long. Accordingly, productivity can be improved double. The working robot 2 and the worker 10 are arranged being opposed to each other across the conveyance conveyor (11A). In view of this, when trouble or the like at the working robot 2 occurs, the opposed worker 10 is easy to respond urgently. For example, the opposed worker 10 can temporarily and easily perform the dish up operation for two rows. Accordingly, this can reduce possibility that a process line stops.

### Installing Tray Supply Device and Tray Recovery Device

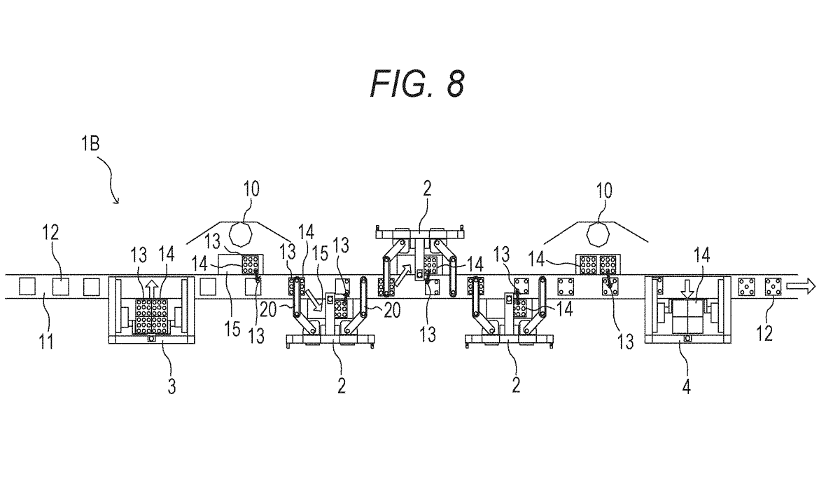

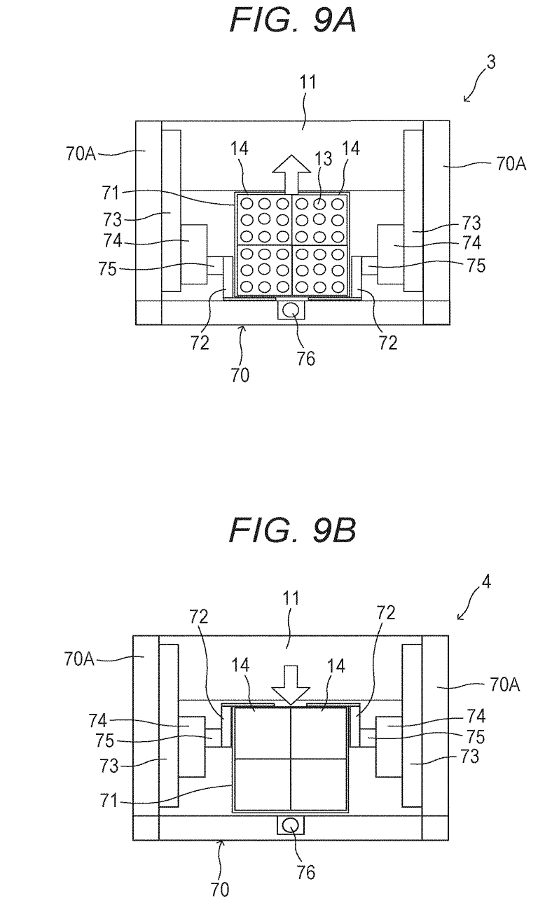

With FIGS. 8, 9A and 9B, a working system (1B) in a second modification will be described. FIG. 8 is an explanatory view representing an exemplary overall configuration of the working system (1B) in the second modification. FIG. 9A is a plan view representing an exemplary configuration of a tray supply device 3. FIG. 9B is a plan view representing an exemplary configuration of a tray recovery device 4.

As illustrated in FIG. 8, the working system (1B) in this modification includes the tray supply device 3 (an exemplary supply device) and the tray recovery device 4 (an exemplary recovery device) at the other side in the width direction (the lower side in FIG. 8) of the conveyance conveyor 11. The tray supply device 3 is disposed at a position at the upstream side with respect to the worker 10 at the upstream side in a conveying direction. The tray recovery device 4 is disposed at a position at the downstream side with respect to the worker 10 at the downstream side in the conveying direction.

As illustrated in FIG. 9A, the tray supply device 3 includes a frame 70, a tray shelf 71, a pair of L-shaped arms 72, a pair of arm front and rear shafts 73, a pair of arm upper and lower shafts 74, a pair of arm rotation shafts 75, and an up-down elevator shaft 76.

The frame 70 includes a pair of cantilevers (70A) projecting above the conveyance conveyor 11. The tray shelf 71 is disposed at approximately a center of the frame 70. Multiple tiers of shelfs where the multiple food product trays 14 that have housed the food products 13 is placed is installed in the vertical direction in the tray shelf 71. The L-shaped arms 72 are an is for extruding the food product tray 14 placed on the tray shelf 71 onto the conveyance conveyor 11. The arm front and rear shafts 73, which are disposed inside the cantilevers (70A), move the L-shaped arms 72 in a front-rear direction. The arm upper and lower shafts 74, which disposed inside the arm front and rear shafts 73, move the L-shaped arms 72 in the vertical direction. The arm rotation shafts 75, which are disposed inside the arm upper and lower shafts 74, rotate the L-shaped arms 72. The up-down elevator shaft 76 moves the respective shelves that the tray shelf 71 includes in the vertical direction.

The tray supply device 3 having the above-described configuration causes the up-down elevator shaft 76 to move one of the multiple shelves in the tray shelf 71 to a supply position. Furthermore, the tray supply device 3 causes the L-shaped arms 72 to extrude the food product tray 14 from the tray shelf 71 moved to the supply position onto the conveyance conveyor 11 at an appropriate timing. Thus, the tray supply device 3 supplies the food product tray 14 to the conveyance conveyor 11.

As illustrated in FIG. 9B, the tray recovery device 4 has a similar configuration to that of the tray supply device 3. At the tray recovery device 4, the empty food product tray 14, which flows on the conveyance conveyor 11, is gripped and drawn to the tray shelf 71 by rotating the L-shaped arms 72 180 degrees around the arm rotation shafts 75. The empty food product tray 14 where the food product 13 has been removed is housed in the tray shelf 71 of the tray recovery device 4.

The tray recovery device 4 having the above-described configuration causes the up-down elevator shaft 76 to move one of the multiple shelves in the tray shelf 71 to the recovery position. Furthermore, the tray recovery device 4 causes the L-shaped arms 72 to grip the empty food product tray 14, which flows on the conveyance conveyor 11, to draw it to the tray shelf 71 moved to the recovery position. Thus, the tray recovery device 4 recovers the empty food product tray 14 from the conveyance conveyor 11.

As described above, the working system (1B) includes the tray supply device 3 and the tray recovery device 4. The tray supply device 3 is disposed at the upstream side of the working robots 2 and the like (including the workers 10) in the conveying direction. The tray supply device 3 supplies the food product tray 14 that houses the food product 13 used for the food product dish up operation that the working robots 2 and the like perform to the conveyance conveyor 11. The tray recovery device 4 is disposed at the downstream side of the working robots 2 and the like. The tray recovery device 4 recovers the food product tray 14 on the conveyance conveyor 11. For example, the tray recovery device 4 recovers the empty food product tray 14 where the working robots 2 and the like have removed the food product 13.

The tray recovery device 4 may recover the food product tray 14 conveyed in front of the tray recovery device 4 itself by the conveyance conveyor 11. For example, the tray recovery device 4 may recover as long as the food product tray 14 is conveyed in front of the tray recovery device 4 itself even if the food product tray 14 is not empty. The food product tray 14 that is not empty includes, for example, the food product tray 14 housing the few food products 13 and the unused food product tray 14 (that remains to house all the food product 13).

The above-described system configuration can automate the supply and the recovery of the food product tray 14 with respect to the conveyance conveyor 11. Accordingly, this can further reduce the number of workers.

### Tray Supply Device and Tray Recovery Device and Food Product Containers Conveyed in Two Rows

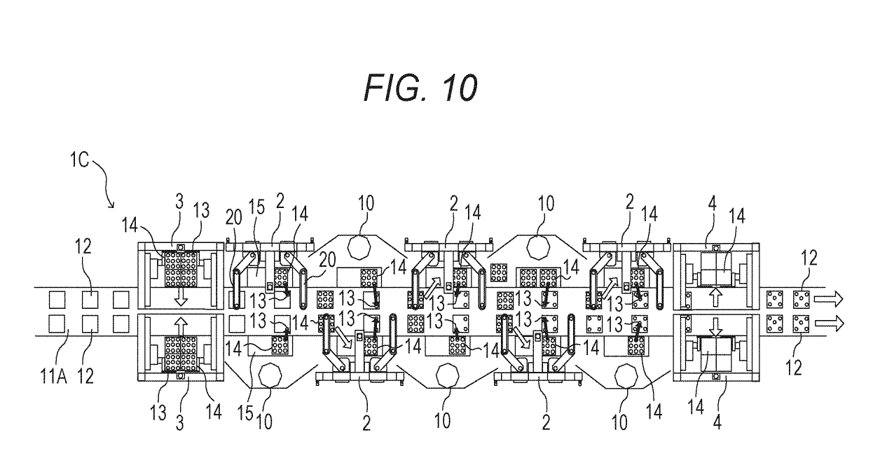

With FIG. 10, a working system (1C) in a third modification will be described.

As illustrated in FIG. 10, in the working system (1C) in this modification, similarly to the above-described first modification, the food product containers 12 and the food product trays 14 are disposed and conveyed, with being mixed at both of a position near one side in the width direction (the upper side in FIG. 10) and a position near the other side in the width direction (the lower side in FIG. 10) on the conveyance conveyor (11A). That is, the food product containers 12 and the food product trays 14 are disposed in two rows and conveyed along a longitudinal direction of the conveyance conveyor (11A) on the conveyance conveyor (11A). Furthermore, in this working system (1C), the tray supply device 3 supplies the food product tray 14 so as to be placed on the conveyance conveyor (11A) in two rows along the longitudinal direction of the conveyance conveyor (11A). In the working system (1C), the tray supply device 3, the working robot 2, and the tray recovery device 4 are disposed at both sides in the longitudinal direction of the conveyance conveyor (11A). At the one side in the width direction of the conveyance conveyor (11A), from the upstream side (the left side in FIG. 10) to the downstream side (the right side in FIG. 10), the tray supply device 3, the working robot 2, the worker 10, the working robot 2, the worker 10, the working robot 2, and the tray recovery device 4 are disposed in this order. At the other side in the width direction of the conveyance conveyor (11A), from the upstream side to the downstream side, the tray supply device 3, the worker 10, the working robot 2, the worker 10, the working robot 2, the worker 10, and the tray recovery device 4 are disposed in this order. Dispositions of the respective working robots 2 and the respective workers 10 are similar to that of the above-described first modification. That is, the respective working robots 2 and the respective workers 10 are disposed so as to be opposed to each other in the width direction of the conveyance conveyor (11A).

This modification, similarly to the above-described first modification, can increase the number of the food product container 12 conveyed by the conveyance conveyor (11A) to improve the productivity. Furthermore, the supply and the recovery of the food product tray 14 with respect to the conveyance conveyor 11 can be automated to reduce the number of workers.

### Disposing Stock Device

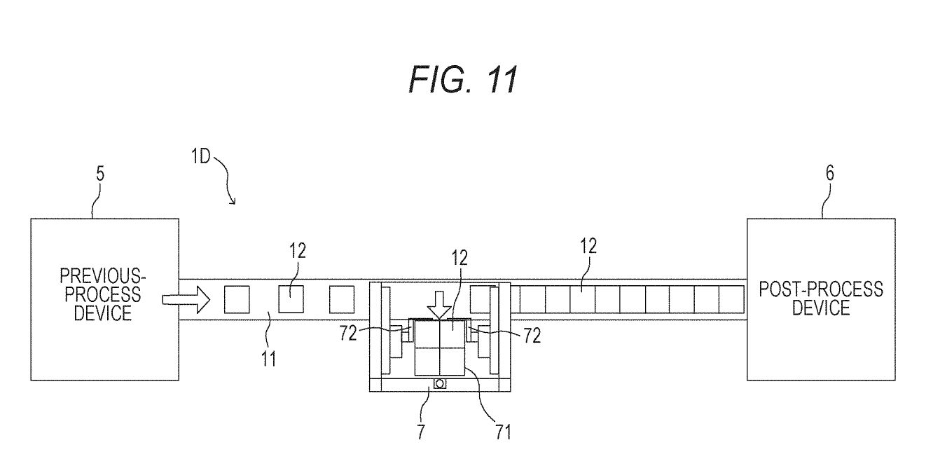

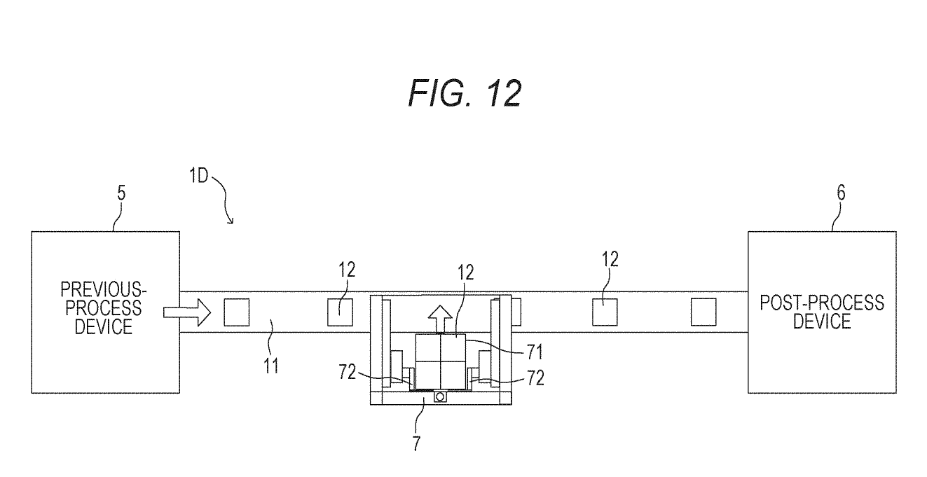

With FIGS. 11 and 12, a working system (1D) in a fourth modification will be described.

As illustrated in FIGS. 11 and 12, the working system (1D) in this modification includes a previous-process device 5, a post-process device 6, and a stock device 7. The previous-process device 5 is a device associated with, for example, a dish up process of the food product 13 into the food product container 12. The previous-process device 5 is corresponding to, for example, the working system 1 in the aforementioned embodiment. The post-process device 6 is a device that performs processes such as fitting the lid on the food product container 12 where the dish up of the food product 13 has been completed by the previous-process device 5.

The stock device 7 is disposed at the proximity of the conveyance conveyor 11. The stock device 7 recovers and stocks the food product container 12 conveyed by the conveyance conveyor 11. The stock device 7 supplies the stocked food product container 12 to the conveyance conveyor 11. The stock device 7 has a configuration similar to that of the aforementioned tray supply device 3 and tray recovery device 4 illustrated in FIGS. 9A and 9B.

As illustrated in FIG. 11, for example, it is supposed that trouble or the like occurs at the post-process device 6 to retain the food product container 12 on the conveyance conveyor 11. In this case, the stock device 7 causes the L-shaped arms 72 to draw the food product container 12 on the conveyance conveyor 11 to stock it temporarily in the tray shelf 71.

Thereafter, as illustrated in FIG. 12, it is supposed that the trouble or the like at the post-process device 6 has been solved to solve the retention of the food product container 12 on the conveyance conveyor 11. In this case, the stock device 7 causes the L-shaped arm 72 to extrude the food product container 12 stocked in the tray shelf 71 to supply the food product container 12 again to the conveyance conveyor 11.

This modification provides next advantageous effects. A process line may be built such that devices associated with the respective processes are arranged along the conveyance conveyor 11. When trouble occurs at a part of the devices, it is preferable to stop the supply of the food product container 12 to this device. In view of this, when it is less likely to stop the process line, for example, the worker 10 responds urgently. For example, the worker 10 manually recovers the food product container 12 to stock it temporarily in a container or the like. After repairing the device, the worker 10 returns the stocked food product container 12 to the conveyance conveyor 11.

According to this modification, the stock device 7 can automatically perform the temporal stock and the return to the conveyance conveyor 11 of the food product container 12. This eliminates a need for ensuring manpower for the above-described urgent response to save manpower cost.

### Others

The case where the working robot 2 includes the horizontal articulated type (the scalar type) robot arm 20 has described above. However, the robot arm 20 is not limited to the scalar type. The robot arm 20 may be other format including a parallel link type, a linear motion type, a vertical articulated type, and the like.

As one example of the work that the working robot 2 performs, the dish up operation of the food product has been described above. However, the work that the working robot 2 performs is not limited to this. For example, the technique of the embodiment is also applicable when the working robot 2 performs a mounting work of parts on a product chassis, or the like.

In the above description, expressions such as “vertical”, “parallel”, and “plane” are not intended to be strictly interpreted. That is, these expressions such as “vertical”, “parallel”, and “plane” allow tolerance and error in design and manufacturing, and the respective expressions mean “substantially vertical”, “substantially parallel”, and “substantially plane”.

In the above description, expressions such as “identical”, “same”, “equal”, and “different” regarding dimension, size, shape, position, and the like in appearance are not intended to be strictly interpreted. That is, these expressions such as “identical”, “same”, “equal”, and “different” allow tolerance and error in design and manufacturing, and the respective expressions mean “substantially identical”, “substantially same”, “substantially equal”, and “substantially different”.

Other than the above description, the method by the above-described embodiment and respective modifications may be used in combination as necessary. Although other is not exemplified one by one, the above-described embodiment and respective modifications may be performed by applying various kinds of changes within the scope of them. The working robot and the working system according to the embodiment may be following first to seventh working robots and first to third working systems.

The first working robot is a working robot that are disposed at the proximity of a conveying device that conveys a workpiece, performs a predetermined work to the workpiece, and characterized by including a robot arm that includes multiple arm members turnably coupled, a control box that houses a controller that controls an operation of the robot arm, and a support frame that supports the control box and the robot arm such that installation positions of the control box and the robot arm overlap viewing from a vertical direction, a clearance is disposed between the control box and the robot arm, and at least one direction of the clearance is in an opened state.

The second working robot is the first working robot, the robot arm is a horizontal articulated type robot arm that includes the arm members which revolve in a horizontal plane, and the working robot is characterized by further including a vertical movement mechanism that is disposed at a base end side of the robot arm and moves the robot arm in a vertical direction.

The third working robot is the second working robot characterized in that the arm members include a first arm member revolvably coupled to the vertical movement mechanism, and a second arm member revolvably coupled to a tip portion of the first arm member, the robot arm further includes a first actuator that is disposed at a base end portion of the first arm member and revolvingly drives the first arm member, and a second actuator that is disposed at a proximity of the first actuator and revolvingly drives the second arm member.

The fourth working robot is the third working robot characterized in that the robot arm includes a bearing disposed at the tip portion of the first arm member, and a hollow structure arm shaft that is disposed at a base end portion of the second arm member and rotatably supported by the bearing.

The fifth working robot is the fourth working robot characterized in that the robot arm includes a drive pulley coupled to an output shaft of the second actuator, a driven pulley coupled to the arm shaft, and a belt wound around the drive pulley and the driven pulley.

The sixth working robot is the fifth working robot characterized in that the robot arm further includes a first arm cover that covers a lower part of the first arm member and a second arm cover that covers an upper part of the second arm member.

The seventh working robot is any of the first to sixth working robots characterized by being a double arm robot including the two robot arms.

The first working system is characterized by that: the first working system includes a conveying device that conveys a workpiece, and a working robot that is disposed at the proximity of the conveying device and performs a predetermined work to the workpiece; the working robot includes a robot arm that includes multiple arm members turnably coupled, a control box that houses a controller that controls an operation of the robot arm, and a support frame that supports the control box and the robot arm such that installation positions of the control box and the robot arm overlap viewing from a vertical direction, a clearance is disposed between the control box and the robot arm; and at least one direction of the clearance is in an opened state, and the conveying device is disposed to pass through the clearance of the working robot.

The second working system is the first working system characterized by further including a supply device that is disposed at an upstream side of the working robot in a conveying direction of the workpiece and supplies a part container where a part necessary for the predetermined work to be performed by the working robot is housed to the conveying device, and a recovery device that is disposed at a downstream side of the working robot in the conveying direction and recovers the part container where the working robot has used the part.

The third working system is the first or second working system characterized by further including a stock device that is disposed at a proximity of the conveying device, recovers and stocks the workpiece conveyed by the conveying device, and supplies the stocked workpiece to the conveying device.

A working robot according to an aspect of the present disclosure includes: a robot arm that includes multiple arm members turnably coupled; a control box that houses a controller that controls an operation of the robot arm; and a support frame that supports the control box and the robot arm such that an installation position of the control box and an installation position of the robot arm overlap viewing from a vertical direction, a clearance is disposed between the control box and the robot arm, and at least one direction of the clearance is in an opened state.

A working system according to another aspect of the present disclosure includes: a working robot that performs a predetermined work for a workpiece, the working robot including: a robot arm that includes multiple arm members turnably coupled; a control box that houses a controller that controls an operation of the robot arm; and a support frame that supports the control box and the robot arm such that an installation position of the control box and an installation position of the robot arm overlap viewing from a vertical direction, a clearance is disposed between the control box and the robot arm, and at least one direction of the clearance is in an opened state, and a conveying device that conveys the workpiece, the conveying device being disposed to pass through the clearance of the working robot.

A working robot according to an embodiment of the present invention and a working system according to an embodiment of the present invention can save space.

Obviously, numerous modifications and variations of the present invention are possible in light of the above teachings. It is therefore to be understood that within the scope of the appended claims, the invention may be practiced otherwise than as specifically described herein.

What is claimed is:

1. A working robot, comprising:
a robot arm comprising a plurality of arm members turnably coupled;
a control box housing a controller that controls operation of the robot arm; and
a support frame supporting the control box and the robot arm such that an installation position of the control box and an installation position of the robot arm overlap when viewing from a vertical direction, a clearance is formed between the control box and the robot arm, and at least one direction of the clearance is in an opened state.

2. The working robot according to claim 1, further comprising:
a vertical movement mechanism positioned at a base end side of the robot arm,
wherein the vertical movement mechanism moves the robot arm in a vertical direction, and the robot arm is a horizontal articulated robot arm comprising the plurality of arm members configured to revolve in a horizontal plane.

3. The working robot according to claim 2, wherein the plurality of arm members includes a first arm member revolvably coupled to the vertical movement mechanism, and a second arm member revolvably coupled to a tip portion of the first arm member, and the robot arm further includes a first actuator that is positioned at a base end portion of the first arm member and revolvingly drives the first arm member, and a second actuator that is positioned at a proximity of the first actuator and revolvingly drives the second arm member.

4. The working robot according to claim 3, wherein the robot arm further includes a bearing positioned at the tip portion of the first arm member, and an arm shaft positioned at a base end portion of the second arm member and rotatably supported by the bearing.

5. The working robot according to claim 4, wherein the robot arm further includes a drive pulley coupled to an output shaft of the second actuator, a driven pulley coupled to the arm shaft, and a belt wound around the drive pulley and the driven pulley.

6. The working robot according to claim 5, wherein the robot arm further includes a first arm cover that covers a lower part of the first arm member.

7. The working robot according to claim 6, wherein the first arm cover is configured to house the bearing, the drive pulley, the driven pulley, and the belt.

8. The working robot according to claim 7, wherein the robot arm further includes a tool positioned at an inferior surface of a tip portion of the second arm member, a third actuator that is positioned at a top surface of the second arm member and rotates the tool, and a second arm cover configured to cover an upper part of the second arm member to house the third actuator.

9. The working robot according to claim 8, wherein the arm shaft has a hollow structure, and a wiring for the third actuator is positioned to pass through an inside of the arm shaft.

10. The working robot according to claim 1, wherein the working robot is a double arm robot including the two robot arms.

11. A working system, comprising:
a working robot configured to perform a predetermined work for a workpiece; and
a conveying device configured to convey the workpiece,
wherein the working robot comprises a robot arm comprising a plurality of arm members turnably coupled, a control box housing a controller that controls operation of the robot arm, and a support frame supporting the control box and the robot arm such that an installation position of the control box and an installation position of the robot a in overlap when viewing from a vertical direction, a clearance is formed between the control box and the robot arm, and at least one direction of the clearance is in an opened state, and the conveying device is positioned to pass through the clearance of the working robot.

12. The working system according to claim 11, further comprising:
a supply device that is positioned at an upstream side of the working robot in a conveying direction of the workpiece and supplies to the conveying device a part container in which a part for the predetermined work is housed; and
a recovery device that is positioned at a downstream side of the working robot in the conveying direction and recovers the part container.

13. The working system according to claim 11, further comprising
a stock device that is positioned at a proximity of the conveying device, recovers and stocks the workpiece conveyed by the conveying device, and supplies the stocked workpiece to the conveying device.

14. The working system according to claim 12, further comprising:
a stock device that is positioned at a proximity of the conveying device, recovers and stocks the workpiece conveyed by the conveying device, and supplies the stocked workpiece to the conveying device.

15. The working system according to claim 11, wherein the working robots are positioned at both sides in a longitudinal direction of the conveying device, and the workpieces are placed in two rows and conveyed along the longitudinal direction of the conveying device on the conveying device.

16. The working system according to claim 12, wherein the working robots, the supply devices, and the recovery devices are positioned at both sides in a longitudinal direction of the conveying device, the workpieces are placed in two rows and conveyed along the longitudinal direction of the conveying device on the conveying device, and the supply devices supply the part containers to be placed in two rows along the longitudinal direction of the conveying device on the conveying device.
